(19) United States
(12) Patent Application Publication
(10) Pub. No.: US 2010/0260660 A1
(43) Pub. Date: Oct. 14, 2010

(54) METHOD FOR PRODUCING CHLORINE BY MULTI STEP ADIABATIC GAS PHASE OXIDATION

(75) Inventors: Ralph Schellen, Dormagen (DE); Leslaw Mleczko, Dormagen (DE); Stephan Schubert, Leverkusen (DE); Oliver Felix Karl Schlüter, Leverkusen (DE); Aurel Wolf, Wulfrath (DE)

Correspondence Address: Briscoe, Kurt G.;Norris McLaughlin & Marcus, PA, 875 Third Avenue, 8th Floor, New York, NY, 10022, US

(73) Assignee: BAYER TECHNOLOGY SERVICES GMBH, LEVERKUSEN (DE)

(21) Appl. No.: 12/668,972

(22) PCT Filed: Jun. 26, 2008
(86) PCT No.: PCT/EP2008/005184

§ 371 Date: Jan. 13, 2010

(30) Foreign Application Priority Data
Jul. 13, 2007 (DE) 10 2007 033 107.1
Jul. 13, 2007 (DE) 10 2007 033 113.6
Jul. 13, 2007 (DE) 10 2007 033 114.4

(51) Int. Cl. C01B 7/04; B01J 8/04

(52) U.S. Cl. 423/502; 422/191

(57) ABSTRACT

The present invention relates to a process for preparing chlorine by catalytic gas phase oxidation of hydrogen chloride with oxygen, in which the reaction is carried out over 18 to 60 catalyst beds connected in series under adiabatic conditions, and to a reactor system for performing the process.

The present invention relates to a process for preparing chlorine by catalytic gas phase oxidation of hydrogen chloride with oxygen, in which the reaction is carried out over 18 to 60 catalyst beds connected in series under adiabatic conditions, and to a reactor system for performing the process.

The process for catalytic hydrogen chloride oxidation with oxygen in an exothermic equilibrium reaction, developed by Deacon in 1868, was the beginning of industrial chlorine chemistry:

4HCl+O₂ [symbol] 2Cl₂+2H₂O

However, chloralkali electrolysis forced the industrial application of the Deacon process very much onto the sidelines. Almost the entire production of chlorine was by electrolysis of aqueous sodium chloride solutions. However, the attractiveness of the Deacon process has increased again in recent times, since the global demand for chlorine is growing more rapidly than the demand for sodium hydroxide solution, a coproduct of NaCl electrolysis. This development is favourable to the process for preparing chlorine by oxidation of hydrogen chloride, which is decoupled from the preparation of sodium hydroxide solution. Furthermore, the hydrogen chloride precursor is easy to obtain; it is obtained as a coproduct in large amounts, for example, in phosgenation reactions, for instance in isocyanate preparation.

The removal and use of the heat of reaction is an important point in the performance of the Deacon process. An uncontrolled temperature rise, which could be 600 to 900° C. from the start to completion of the Deacon reaction, would firstly lead to permanent damage to the catalyst, and high temperatures secondly cause an unfavourable shift in the reaction equilibrium in the direction of the reactants with a corresponding deterioration in the yield. It is therefore desirable to keep the temperature of the catalyst bed within a range of 150 to 600° C. in the course of the process.

In established processes, the catalyst is therefore used in the form of a fluidized, thermally stabilized bed. According to EP 0 251 731 A2, the temperature of the catalyst bed is controlled through the outer wall; according to DE 10 2004 006 610 A1, the temperature of the fluidized bed is controlled by means of a heat carrier arranged in the bed. Effective heat removal from this process is countered by problems resulting from an inhomogeneous residence time distribution and catalyst attrition, both of which lead to losses of conversion.

A narrow residence time distribution and low catalyst attrition are possible in reactors with stationary catalyst beds. However, there are problems with the thermostating of the catalyst beds in such reactors. In general, thermostated tube bundle reactors are therefore used, which, particularly in the case of large reactors, possess a very complicated cooling circuit (WO 2004/052776 A1).

In order to improve the heat removal from the catalyst bed, the R&D Report, “Sumitomo Kagaku”, Vol. 2004-I proposes the use of a fixed bed catalyst composed of ruthenium oxide on titanium oxide as a support. In addition to the high catalyst activity, the good thermal conductivity of the catalyst system is specified as an advantage. Since the thermal conductivity of the bed remains low even in the case of a high thermal conductivity within the catalyst bed, the heat removal is, however, not significantly improved by this measure.

EP 1 170 250 A1 proposes the use of catalyst charges in tube bundle reactors, each of which have different activities in different regions of the cooled catalyst tubes. This slows the progress of the reaction to such an extent that the heat of reaction which arises can be removed more readily via the wall of the catalyst tubes. A similar result is said to be achieved through the controlled dilution of the catalyst bed with inert material. Disadvantages of these solutions is that two or more catalyst systems have to be developed and used in the catalyst tubes, and that use of inert material impairs the reactor capacity.

Published specifications WO 2004/037718 and WO 2004/014845 mention, in general form, the possibility of adiabatic catalytic hydrogen chloride oxidation as well as the preferred isothermal processes. However, specific embodiments of an adiabatic hydrogen chloride oxidation are not described. It thus remains entirely unclear how the heat of reaction of the exothermic reaction can be removed and damage to the catalyst can be avoided in a fully adiabatic operating mode of the overall process. In fact, the hydrogen chloride oxidation, according to these documents, however, proceeds isothermally as a fixed bed process in tube bundle reactors, which, as already mentioned, require a cooling system which has to be controlled in a complicated manner. In principle, all tube bundle reactors described are also very complex and cause high capital costs. Problems regarding mechanical stability and homogeneous thermostating of the catalyst bed which rise rapidly with construction size make large units of such a type uneconomic.

It would therefore be advantageous to provide a simple process which can be carried out in a simple reactor without a complicated system for heat management in the reactor. Such reactors would be easy to convert to an industrial scale and are inexpensive and robust in all parameters. In this reactor type, the reaction enthalpy is reflected quantitatively in the temperature difference between reactant and product gas stream.

For the exothermic gas phase oxidation of hydrogen chloride with a gas stream comprising oxygen, to date, neither has the use of such reactors been described nor have suitable catalysts and suitable processes been indicated.

The catalysts first used for the Deacon process, for instance supported catalysts with the active composition of CuCl₂, had only a low activity. Although it was possible to enhance the activity by increasing the reaction temperature, it was disadvantageous that the volatility of the active components at relatively high temperature led to a rapid deactivation of the catalyst. The oxidation of hydrogen chloride to chlorine is additionally an equilibrium reaction. The equilibrium position shifts away from the desired end product with increasing temperature.

Typically, catalysts with maximum activity which allow the reaction to proceed at low temperature are therefore used. Known high-activity catalysts are based on ruthenium. DE-A 197 48 299 describes supported catalysts with the active composition comprising ruthenium oxide or a mixed ruthenium oxide. The content of ruthenium oxide is 0.1% by weight to 20% by weight and the mean particle diameter of ruthenium oxide is 1.0 nm to 10.0 nm. The reaction is carried out at a temperature between 90° C. and 150° C. Further supported catalysts based on ruthenium are known from DE-A 197 34 412: ruthenium chloride catalysts which comprise at least one compound from titanium oxide and zirconium oxide, ruthenium-carbonyl complexes, ruthenium salts of inorganic acids, ruthenium-nitrosyl complexes, ruthenium-amine complexes, ruthenium complexes of organic amines or ruthenium-acetylacetonate complexes. The reaction is carried out at a temperature between 100° C. and 500° C., preferably 200° C. and 380° C. In the two applications DE-A 197 48 299 and DE-A 197 34 412, the catalyst is used in a fixed bed or in a moving bed. The starting oxygen substance used is air or pure oxygen. However, the Deacon reaction remains an exothermic reaction and temperature control is also required in the case of use of such high-activity catalysts.

It is therefore an object of the invention to provide a process for catalytic oxidation of hydrogen chloride to chlorine, which can be performed in a simple reactor without a complex system for heat management in the reactor.

The inventors of the present invention found that, surprisingly, it is possible to achieve the objects described above by carrying out the reaction over 18 to 60 catalyst beds connected in series under adiabatic conditions.

The process gas may, as well as oxygen and hydrogen chloride, also comprise secondary constituents, for example nitrogen, carbon dioxide, carbon monoxide or water. The hydrogen chloride may originate from upstream production processes, for example for preparing polyisocyanates, and comprise further impurities, for example phosgene.

According to the invention, the performance of the process under adiabatic conditions over the catalyst beds means that essentially neither is any heat supplied externally to nor is any heat withdrawn from the catalyst in the particular catalyst beds (with the exception of the heat which is supplied and removed through entering or exiting reaction gas). In technical terms, this is done by insulation of the catalyst beds in a manner known per se. The individual catalyst beds are operated adiabatically; more particularly, no heat removal means are thus provided therein. When the process is viewed as a whole, the invention also includes the case in which the heat of reaction is removed, for example, by means of heat exchangers connected between the individual catalyst beds.

The advantages of the inventive adiabatic operating mode of 18 to 60 catalyst beds connected in series over the conventional isothermal operating mode consist in particular in that no means of removing heat have to be provided in the catalyst beds, which implies a considerable simplification of the construction. This gives rise more particularly to simplifications in the manufacture of the reactor and in the scalability of the process and a rise in the reaction conversions.

Catalyst bed is understood here to mean an arrangement of the catalyst in all manifestations known per se, for example fixed bed, moving bed or fluidized bed. Preference is given to a fixed bed arrangement. This includes a catalyst bed in the actual sense, i.e. loose, supported or unsupported catalyst in any form and in the form of suitable packings:

The term “catalyst bed” as used here also includes continuous regions of suitable packings on a support material or structured catalyst supports. Examples of these include ceramic honeycombs which have comparatively high geometric surface areas and are to be coated, or corrugated sheets of metal wire mesh on which, for example, catalyst granules are immobilized.

In the novel process, preference is given to using stationary catalyst beds.

In a preferred embodiment of the process according to the invention, the reaction is effected over 20 to 40 and preferably 22 to 30 catalyst beds connected in series.

A preferred further embodiment of the process is characterized in that the process gas mixture leaving at least one catalyst bed is subsequently passed through at least one heat exchanger connected downstream of the catalyst bed.

In a particularly preferred further embodiment of the process, disposed downstream of each catalyst bed is at least one, preferably one, heat exchanger through which the emerging process gas mixture is passed.

In a preferred embodiment, at least one heat exchanger is disposed at least downstream of one catalyst bed. More preferably, at least one, more preferably in each case exactly one, heat exchanger through which the gas mixture leaving the catalyst bed is passed is disposed downstream of each of the catalyst beds.

The catalyst beds may either be arranged in a reactor or be arranged divided within a plurality of reactors. The arrangement of the catalyst beds in one reactor leads to a reduction in the number of the apparatus used.

In addition, individual catalyst beds among those connected in series can independently also be replaced or supplemented by one or more catalyst beds connected in parallel. The use of catalyst beds connected in parallel allows, more particularly, their exchange or supplementation in the course of continuous overall operation of the process.

The process according to the invention, however, preferably has 18 to 60 catalyst beds connected in series. Catalyst beds connected in parallel and in series can especially also be combined with one another. More preferably, the process according to the invention, however, has exclusively catalyst beds connected in series.

When catalyst beds connected in parallel are used, especially a maximum of 5, preferably 3 and more preferably a maximum of 2 process lines consisting of catalyst beds connected in series are connected in parallel.

The reactors used with preference in the process according to the invention may consist of simple vessels with one or more thermally insulated catalyst beds, as described, for example, in Ullmanns Encyclopedia of Industrial Chemistry (Fifth, Completely Revised Edition, Vol B4, page 95-104, page 210-216). In other words, they may, for example, be simple or multistage fixed bed reactors, radial flow reactors or else shallow bed reactors. Tube bundle reactors are, however, preferably not used owing to the disadvantages described above. Since there is no removal of heat from the catalyst beds in accordance with the invention, such reactor types for the accommodation of the catalyst beds are also unnecessary.

The catalysts or the catalyst beds thereof are accommodated in a manner known per se on or between gas-pervious walls of the reactor. Especially in the case of thin catalyst beds, technical devices for homogeneous gas distribution are mounted above, below or above and below the catalyst beds. These may be perforated plates, bubble-cap trays, valve trays or other internals which, by generating a small but homogeneous pressure drop, bring about homogeneous entry of the gas into the catalyst bed.

The superficial velocity of the gas in the catalyst bed in the case of the embodiment using a fixed bed is preferably 0.1 to 10 m/s.

In a particular embodiment of the process according to the invention, preference is given to using a molar ratio of between 0.25 and 10 equivalents of oxygen per equivalent of hydrogen chloride before entry into the catalyst bed. An increase in the ratio of equivalents of oxygen per equivalent of hydrogen chloride can firstly accelerate the reaction and hence increase the space-time yield (amount of chlorine produced per unit reactor volume), and the equilibrium of the reaction is secondly shifted positively in the direction of the products.

In a further particularly preferred embodiment of the process, the entrance temperature of the gas mixture entering a first catalyst bed is 150 to 630° C., preferably 200 to 480° C.

The starting gas stream comprising hydrogen chloride and oxygen can also preferably be supplied only upstream of the first catalyst bed. This has the advantage that the overall starting gas stream can be utilized for the absorption and removal of the heat of reaction in all catalyst beds. However, it is also possible if required to meter hydrogen chloride and/or oxygen into the gas stream upstream of one or more of the catalyst beds downstream of the first catalyst bed. The supply of gas between the catalyst beds used additionally allows the temperature of the reaction to be controlled.

In a particularly preferred embodiment of the process according to the invention, the reaction gas is cooled downstream of at least one of the catalyst beds used, more preferably downstream of each of the catalyst beds used. To this end, the reaction gas is passed through one or more heat exchangers which are disposed downstream of the particular catalyst beds. These may be heat exchangers known to those skilled in the art, for example tube bundle heat exchangers, plate heat exchangers, annular groove heat exchangers, spiral heat exchangers, ribbed tube heat exchangers, micro-heat exchangers. In a particular embodiment of the process, steam can be raised when the product gas is cooled in the heat exchangers.

In a preferred embodiment of the process, the catalyst beds connected in series are operated at an average temperature rising or falling from catalyst bed to catalyst bed. This means that, within a sequence of catalyst beds, the temperature from catalyst bed to catalyst bed can be allowed either to rise or fall. For instance, it may be particularly advantageous first to allow the average temperature to rise from catalyst bed to catalyst bed to increase the catalyst activity, and then to allow the average temperature to fall again in the downstream last catalyst beds to shift the equilibrium. This can be established, for example, via the control of the heat exchangers connected between the catalyst beds. Further means of adjusting the average temperature are described below.

In a preferred step connected downstream of the novel process, the chlorine formed is removed. The removal step typically comprises several stages, specifically the removal and optional recycling of unconverted hydrogen chloride from the product gas stream of the catalytic hydrogen chloride oxidation, the drying of the resulting stream comprising essentially chlorine and oxygen, and the removal of chlorine from the dried stream.

Unconverted hydrogen chloride and steam formed can be removed by condensing aqueous hydrochloric acid out of the product gas stream of the hydrogen chloride oxidation by cooling. Hydrogen chloride can also be absorbed in dilute hydrochloric acid or water.

In a preferred embodiment of the process, unconverted hydrogen chloride and/or oxygen, after removal of chlorine and water from the product stream and after branching off a small amount of gas to keep gaseous components constant, some of which are entrained with the reactants, are fed back to the reaction. The hydrogen chloride and/or oxygen recycled are recycled upstream of one or more of the catalyst beds and, beforehand, if appropriate, brought back to entrance temperature by means of a heat exchanger. Advantageously, the cooling of the product gas and the heating of the hydrogen chloride and/or oxygen recycled are accomplished by conducting the gas streams past one another in countercurrent by means of heat exchangers.

The novel process is operated preferably at a pressure of 1 to 30 bar, preferably of 1 to 20 bar, more preferably of 1 to 15 bar.

The temperature of the reactant gas mixture upstream of each of the catalyst beds is preferably 150 to 630° C., preferably 200 to 480° C., more preferably 250 to 470° C. The gas mixture is preferably homogenized before entry into the individual catalyst bed.

The thickness of the catalyst beds which are flowed through may be selected at identical or different levels and is appropriately 1 cm to 8 m, preferably 5 cm to 5 m, more preferably 30 cm to 2.5 m.

The catalyst is preferably used immobilized on a support. The catalyst preferably comprises at least one of the following elements: copper, potassium, sodium, chromium, cerium, gold, bismuth, uranium, ruthenium, rhodium, platinum, and an element of transition group VIII of the Periodic Table of the Elements. These are preferably used in the form of oxides, halides or mixed oxides/halides, especially chlorides or oxides/chlorides. These elements or compounds thereof can be used alone or in any combination.

Preferred compounds of these elements include: copper chloride, copper oxide, potassium chloride, sodium chloride, chromium oxide, bismuth oxide, uranium oxide, ruthenium oxide, ruthenium chloride, ruthenium oxychloride, rhodium oxide.

More preferably, the catalyst fraction consists entirely or partly of ruthenium and/or uranium or compounds thereof; more preferably, the catalyst consists of halide- and/or oxygen-containing uranium and/or ruthenium compounds.

Most preferably, the catalyst fraction consists entirely or partly of uranium oxides, for example UO₃, UO₂, UO or the nonstoichiometric phases resulting from mixtures of these species, for example U₃O₅, U₂O₅, U₃O₇, U₃O₈, U₄O₉.

The support fraction may consist entirely or partly of: titanium oxide, tin oxide, aluminium oxide, zirconium oxide, uranium oxide, vanadium oxide, cerium dioxide, chromium oxide, silicon oxide, siliceous earth, carbon nanotubes, or a mixture or compound of the substances mentioned, especially mixed oxides such as silicon-aluminium oxides. Particularly preferred support materials are tin oxide, carbon nanotubes, uranium oxides, for example UO₃, UO₂, UO and the nonstoichiometric phases resulting from mixtures of these species, for example U₃O₅, U₂O₅, U₃O₇, U₃O₈, U₄O₉.

The supported ruthenium catalysts can be obtained, for example, by impregnating the support material with aqueous solutions of RuCl₃ and optionally of a promoter for doping. The catalyst can be shaped after or preferably before the impregnation of the support material.

For the doping of the catalysts, suitable promoters are alkali metals such as lithium, sodium, potassium, rubidium and caesium, preferably lithium, sodium and potassium, more preferably potassium, alkaline earth metals such as magnesium, calcium, strontium and barium, preferably magnesium and calcium, more preferably magnesium, rare earth metals such as scandium, yttrium, lanthanum, cerium, praseodymium and neodymium, preferably scandium, yttrium, lanthanum and cerium, more preferably lanthanum and cerium, or mixtures thereof.

The shaped bodies can subsequently be dried at a temperature of 100 to 400° C., preferably 100 to 300° C., for example under a nitrogen, argon or air atmosphere, and optionally calcined. Preferably, the shaped bodies are first dried at 100 to 150° C. and then calcined at 200 to 400° C.

The temperature of the catalyst in the catalyst beds is appropriately within a range of 150° C. to 800° C., preferably 200° C. to 450° C., more preferably 250° C. to 400° C. The temperature in the catalyst beds is controlled preferably by at least one of the following measures:
dimensioning of the catalyst beds,
control of the heat removal between the catalyst beds,
addition of starting gases between the catalyst beds,
molar ratio of the reactants,
concentration of the reactants,
addition of inert gases, especially nitrogen, carbon dioxide, before and/or between the catalyst beds.

In principle, the catalysts or the supported catalysts may have any desired shape, for example spheres, rods, Raschig rings, or granules or tablets.

The composition of the catalysts in the catalyst beds used in accordance with the invention may be the same or different. In a preferred embodiment, the same catalysts are used in each catalyst bed. However, it is also advantageously possible to use different catalysts in the individual catalyst beds. For instance, especially in the first catalyst bed when the concentration of the reaction products is still high, a less active catalyst can be used, and, in the further catalyst beds, the activity of the catalyst can be increased from catalyst bed to catalyst bed. The catalyst activity can also be controlled by dilution with inert materials or support material.

The process according to the invention can be used to prepare 0.1 g/h to 10 g/h of chlorine, preferably 0.5 g/h to 5 g/h of chlorine, per 1 g of catalyst. The process according to the invention is notable for high space-time yields, combined with a reduction in the apparatus sizes and a simplification of the apparatus and reactors.

The reactant for the process according to the invention is hydrogen chloride which is produced and adopted, for example, as a coproduct from the phosgenation of organic amines, especially diamines, to isocyanates, especially diisocyanates, or the gas phase phosgenation of phenol to diphenyl carbonate.

Oxygen can be supplied in the form of pure oxygen or preferably in the form of an oxygen-containing gas, especially air.

The chlorine produced can be used, for example, to prepare phosgene and optionally recycled into associated production processes.

In a further embodiment of the present invention, the process is conducted such that a continuous exchange of a fixed bed catalyst takes place.

In a further embodiment of the present invention, unconverted reactant gases are recycled back into the process. Unconverted reactant gases are especially hydrogen chloride and oxygen. The process is thus operated as a circulation process.

The invention further provides a reactor system for converting a gas comprising hydrogen chloride and oxygen, at least comprising feed lines for hydrogen chloride and oxygen or for a mixture of hydrogen chloride and oxygen, and 18 to 60 thermally insulated catalyst beds connected in series. The reactor system may also comprise 20 to 40 or 22 to 30 catalyst beds.

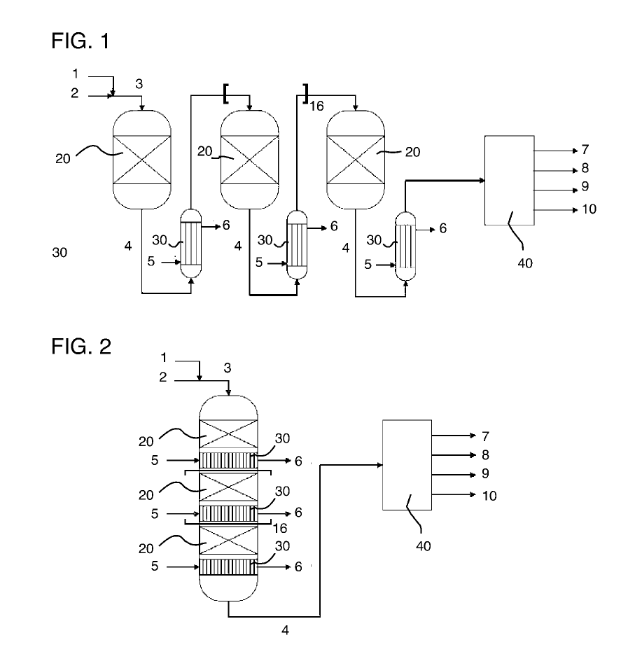

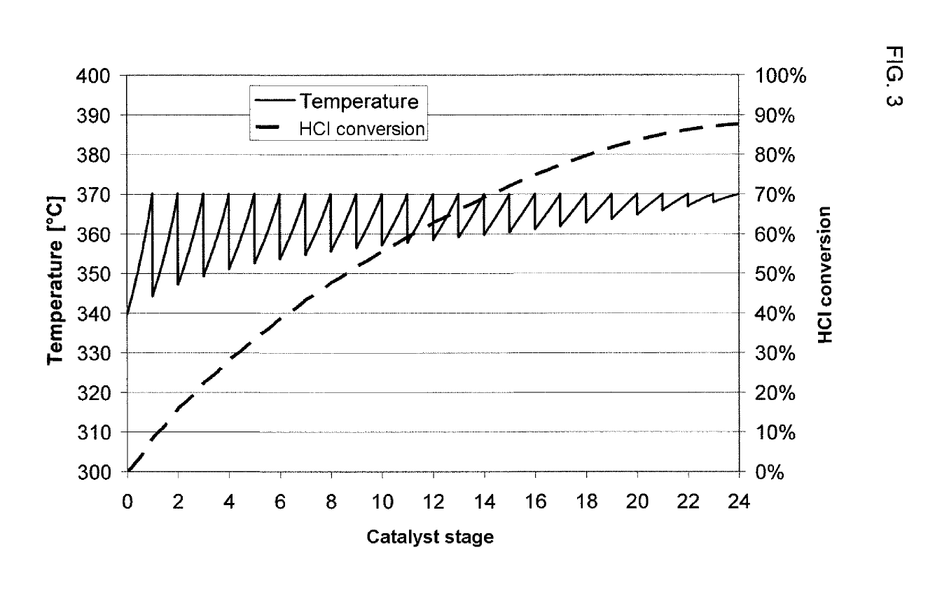

The present invention is illustrated with reference to FIGS. 1 and 2. The figures show:

FIG. 1 an inventive process procedure with 18 catalyst beds divided between separate reactors

FIG. 2 an inventive process procedure with 18 catalyst beds in an integrated reactor

FIG. 1 shows an inventive process procedure with 18 catalyst beds divided between separate reactors. Upstream of the first of the reactors, the reactant gases (1, 2) are mixed to give gas mixture (3) and supplied to the reactor. The reactors each comprise a catalyst bed (20). The product gases of the reactors (4) are passed through heat exchangers (30). The heat exchanger (30) comprises feed lines (5) and removal lines (6) for cooling medium. FIG. 1 symbolizes the fact that a repeat unit of reactor with catalyst bed (20) and heat exchanger (30) is repeated a total of 16 times, and so a total of 18 units are shown. The product gas mixture is finally subjected to a substance separation (40) and separated into hydrogen chloride (7), oxygen (8), chlorine (9) and water (10). It is also possible to recycle unreacted hydrogen chloride gas (7) and oxygen gas (8) back into the reactors. However, this is not shown here.

FIG. 2 shows an inventive process procedure with 18 catalyst beds in an integrated reactor. Upstream of the first of the reactors, the reactant gases (1, 2) are mixed to give gas mixture (3) and supplied to the reactor. The reactors each comprise a catalyst bed (20). The product gases of the reactors (4) are passed through heat exchangers (30). The heat exchanger (30) comprises feed lines (5) and removal lines (6) for cooling medium. FIG. 2 symbolizes the fact that a repeat unit of reactor with catalyst bed (20) and heat exchanger (30) is repeated a total of 16 times, and so a total of 18 units are shown. The product gas mixture is finally subjected to a substance separation (40) and separated into hydrogen chloride (7), oxygen (8), chlorine (9) and water (10). It is also possible to recycle unreacted hydrogen chloride gas (7) and oxygen gas (8) back into the reactors. However, this is not shown here.

The present invention is also illustrated in detail with reference to Examples 1 and 2 which follow. These examples relate to the number of catalyst beds and the temperature profile of the process gas mixture when it is reacted in reaction zones by the process according to the invention and cooled again in downstream heat exchangers. The examples further relate to the conversion of HCl achieved.

### EXAMPLES

### Example 1

In this example, the process gas mixture flowed through a total of 24 catalyst stages, i.e. through 24 reaction zones. Downstream of each catalyst stage was disposed a heat exchanger which cooled the process gas mixture before it entered the next catalyst stage. The process gas used at the outset was a mixture of HCl (38.5 mol %), O₂ (38.5 mol %) and inert gases (Ar, Cl₂, N₂, CO₂; 23 mol % in total). The entrance pressure of the process gas mixture was 5 bar. The length of the catalyst stages, i.e. of the reaction zones, was uniform and was in each case 7.5 cm. The activity of the catalyst was adjusted such that it was the same in all catalyst stages. The process was carried out such that a loading of 1.2 kg of HCl per kg of catalyst and hour was attained. There was no metered addition of further process gas constituents upstream of the individual catalyst stages. The residence time in the plant was a total of 2.3 seconds.

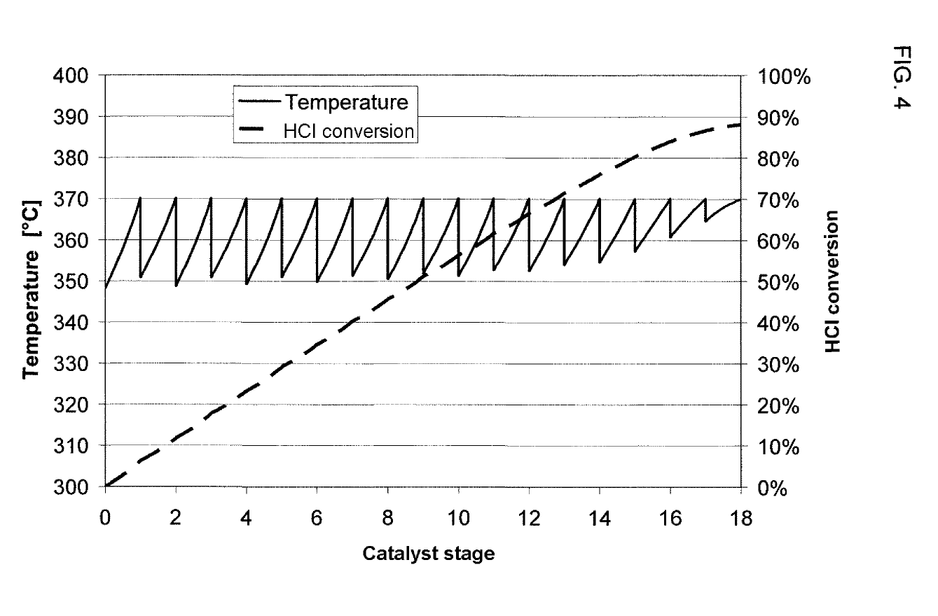

The results are shown in FIG. 3. The individual catalyst stages are shown on the x axis, such that a spatial profile of the developments in the process becomes visible. On the left-hand y-axis, the temperature of the process gas mixture is specified. The temperature profile over the individual catalyst stages is shown as a continuous line. On the right-hand y-axis, the overall conversion of HCl is specified. The profile of the conversion over the individual catalyst stages is shown as a broken line.

It can be seen that the entrance temperature of the process gas mixture upstream of the first catalyst stage is about 340° C. As a result of the exothermic reaction to give chlorine gas under adiabatic conditions, the temperature rises to about 370° C., before the process gas mixture is cooled again by the downstream heat exchanger. The entrance temperature upstream of the next catalyst stage is about 344° C. As a result of exothermic adiabatic reaction, it rises again to about 370° C. The sequence of heating and cooling continues further. The entrance temperatures of the process gas mixture upstream of the individual catalyst stages rise with increasing number of stages. This is possible since the amount of reactants capable of reaction is lower at stages later in the reaction and, correspondingly, the risk that the temperature will leave the optimal range of the process as a result of the exothermic reaction falls. Consequently, the temperature of the process gas mixture can be kept closer to the optimal temperature for the particular composition.

The conversion of HCl after the 24th stage was 88.1% overall.

### Example 2

In this example, the process gas mixture flowed through a total of 18 catalyst stages, i.e. through 18 reaction zones. Downstream of each catalyst stage was disposed a heat exchanger, which cooled the process gas mixture before it entered the next catalyst stage. The process gas used at the outset was a mixture of HCl (38.5 mol %), O₂ (38.5 mol %) and inert gases (Ar, Cl₂, N₂, CO₂; 23 mol % in total). The entrance pressure of the process gas mixture was 5 bar. The length of the catalyst stages, i.e. of the reaction zones, was uniform and was in each case 15 cm. The activity of the catalyst was adjusted such that it increased with the number of catalyst stages. The relative catalyst activities were as follows:

| | |
|---|---|
| Stages 1 and 2 | 30% |
| Stages 3 and 4 | 40% |
| Stages 5 and 6 | 50% |
| Stages 7 and 8 | 60% |
| Stages 9 and 10 | 70% |
| Stages 11 and 12 | 80% |
| Stages 13 and 14 | 90% |
| Stages 15 and 16 | 100% |
| Stages 17 and 18 | 100% |

The process was carried out such that a loading of 1.12 kg of HCl per kg of catalyst and hour was achieved. There was no metered addition of further process gas constituents upstream of the individual catalyst stages. The residence time in the plant was a total of 3.5 seconds.

The results are shown in FIG. 4. The individual catalyst stages are shown on the x-axis, such that a spatial profile of the developments in the process becomes visible. On the left-hand y-axis, the temperature of the process gas mixture is specified. The temperature profile over the individual catalyst stages is shown as a continuous line. On the right-hand y-axis, the overall conversion of HCl is specified. The profile of the conversion over the individual catalyst stages is shown as a broken line.

It can be seen that the entrance temperature of the process gas mixture upstream of the first catalyst stage is about 350° C. As a result of the exothermic reaction to give chlorine gas under adiabatic conditions, the temperature rises to about 370° C., before the process gas mixture is cooled again by the downstream heat exchanger. The entrance temperature upstream of the next catalyst stage is again about 350° C. As a result of exothermic adiabatic reaction, it rises again to about 370° C. The sequence of heating and cooling continues further. The entrance temperatures of the process gas mixture upstream of the individual catalyst stages rise with increasing number of stages more slowly than in the case of Example 1. Overall, the variability of the process gas temperatures is actually lower. The intentional lower activity of the catalyst in the early stages enables the process gas mixture to be introduced with a higher entrance temperature without any risk of undesired overheating. Consequently, the temperature of the process gas mixture can be kept closer to the optimal temperature for the particular composition.

The conversion of HCl after the 18th stage was 88.1% overall.

### LIST OF REFERENCE NUMERALS

1 hydrogen chloride (reactant)
2 oxygen (reactant)
3 mixed reactant gas stream
4 product gases of the reactors
5 supply of cooling medium
6 removal of cooling medium
7 hydrogen chloride (from product gas)
8 oxygen (from product gas)
9 chlorine
10 water
16 is not a reference numeral, but rather symbolizes 16 repeat units
20 reactor bed
30 heat exchanger
40 substance separation

1. A process for preparing chlorine comprising the step of catalytic gas phase oxidation of hydrogen chloride with oxygen, wherein the reaction of hydrogen chloride with oxygen is carried out over 18 to 60 catalyst beds connected in series under adiabatic conditions.

2. The process according to claim 1, wherein the reaction is effected over 20 to 40 catalyst beds connected in series.

3. The process according to claim 1, wherein the temperature of the catalyst in the catalyst beds during the reaction, is 150° C. to 800° C.

4. The process according to claim 1, wherein the process gas mixture leaving at least one catalyst bed is then passed through at least one heat exchanger connected downstream of the catalyst bed.

5. The process according to claim 4, wherein downstream of each catalyst bed is disposed at least one heat exchanger, preferably a single heat exchanger, through which the emerging process gas mixture is passed, and in that the heat exchanger is preferably selected from the group comprising tube bundle heat exchangers, plate heat exchangers, annular groove heat exchangers, spiral heat exchangers, ribbed tube heat exchangers and/or micro-heat exchangers.

6. The process according to claim 4, wherein the heat of reaction removed in the heat exchanger is used to raise steam.

7. The process according to claim 1, wherein the reaction is carried out at a pressure of 1 to 30 bar.

8. The process according to claim 1, wherein the entrance temperature of the gas mixture entering a first catalyst bed is 150 to 630° C.

9. The process according to claim 8, in which the entrance temperature of the gas mixture entering each of the catalyst beds is 150 to 630° C.

10. The process according to claim 1, wherein the catalyst beds connected in series are operated at an average temperature rising or falling from catalyst bed to catalyst bed.

11. The process according to claim 1, wherein the molar ratio of oxygen to hydrogen chloride before entry into each catalyst bed is 0.25 to 10 equivalents of oxygen per equivalent of hydrogen chloride.

12. The process according to claim 1, wherein one or more individual catalyst beds may independently be replaced by in each case two or more parallel catalyst beds.

13. The process according to claim 1, wherein the starting gas stream comprising hydrogen chloride and oxygen is supplied only to the first catalyst bed.

14. The process according to claim 1, wherein fresh hydrogen chloride and/or oxygen is metered into the process gas stream upstream of one or more catalyst beds arranged downstream of the first catalyst bed.

15. The process according to claim 1, wherein the catalyst comprises at least one element which is selected from the group consisting of: copper, potassium, sodium, chromium, cerium, gold, bismuth, uranium, ruthenium, rhodium, platinum, and an element of transition group VIII of the Periodic Table of the Elements.

16. The process according to claim 1, wherein the catalyst is based on ruthenium and/or uranium or a ruthenium and/or uranium compound.

17. The process according to claim 1, wherein the activity of the catalysts in the different catalyst beds is different and more particularly rises from catalyst bed to catalyst bed.

18. The process according to claim 1, wherein the catalyst of the catalyst beds is applied to an inert support.

19. The process according to claim 18, wherein the catalyst support consists entirely or partly of titanium oxide, tin oxide, aluminium oxide, zirconium oxide, vanadium oxide, cerium dioxide, chromium oxide, silicon oxide, uranium oxide, siliceous earth, carbon nanotubes, or a mixture or compound of the substances mentioned.

20. The process according to claim 1, wherein a continuous exchange of a fixed bed catalyst takes place.

21. The process according to claim 1, wherein unconverted reactant gases are recycled back into the process.

22. A reactor system for converting a gas comprising hydrogen chloride and oxygen, at least comprising feed lines for hydrogen chloride and oxygen or for a mixture of hydrogen chloride and oxygen, and 18 to 60 thermally insulated catalyst beds connected in series.
